(19) United States
(12) Patent Application Publication
(10) Pub. No.: US 2007/0163628 A1
(43) Pub. Date: Jul. 19, 2007

(54) Method for diafiltration of a product and device for carrying out this method

(75) Inventor: Edgar Zimmer, Lauchringen (DE)

Correspondence Address: COHEN, PONTANI, LIEBERMAN & PAVANE, 551 FIFTH AVENUE, SUITE 1210, NEW YORK, NY, 10176, US

(73) Assignee: Bucher Guyer AG, Niederweningen (CH)

(21) Appl. No.: 10/589,707

(22) PCT Filed: Jan. 26, 2005
(86) PCT No.: PCT/CH05/00039

§ 371 Date: Aug. 16, 2006

(30) Foreign Application Priority Data
Feb. 18, 2004 (CH) 260/04

(51) Int. Cl. B08B 3/00

(52) U.S. Cl. 134/134

(57) ABSTRACT

The invention relates to a diafiltration stage for concentrated fruit juices, comprising a cross-flow filtration element (1). The product inlet (2) and the product outlet (3) of the filtration element (1) are united via a circulation pump (5) to form a product circuit, to which product is continuously supplied via a product supply line (6) and from which product can be continuously removed via a product discharge line (8). The permeate outlet (4) of the filtration element (1) is connected to the product circuit via a return line (1) comprising a permeate pump (13), enabling a desired amount of permeate to be returned to the product circuit. In addition, the stage comprises a wash-fluid supply line (10) that is equipped with a wash-fluid pump (12), which is used to supply a desired amount of water to the product circuit as wash fluid. The supplied amounts of permeate and water can be set independently of one another. Said diafiltration stage permits both the degree of washing of the product and the quality and amount of the product retentate and the permeate that is produced to be set and regulated within a wide range, even for fixed operating conditions, such as those required in continuous multi-stage large-scale installations.

### TECHNICAL FIELD

The invention concerns a method for the diafiltration of a product, a device for carrying out this method, a filtration plant that uses this device, and the use of the device and the filtration plant in accordance with the introductory clauses of the independent claims.

### PRIOR ART

Diafiltration is the filtration of a product with membrane filtration means with the addition of a wash fluid to the product, which causes the concentration of filterable constituents in the product to decrease, i.e., these substances are washed out without the nonfilterable constituents in the product necessarily being concentrated or the product becoming thickened. Wash fluids that are used are wash fluids external to the product, such as separately supplied water or solvent, permeate derived from the product itself, which is removed, for example, from a downstream diafiltration stage, or a mixture of the two (see also R. F. Madsen, Design of Sanitary and Sterile UF and Diafiltration Plants, Separation and Purification Technology, 22-23 (2001) 79-87). However, the exclusive return of permeate from the membrane filtration means into the product stream, as is occasionally used to control the permeate output, does not constitute diafiltration, for washing out does not occur in this case, but rather the filterable constituents are merely circulated in a circulation system.

All of the diafiltration methods presently known have the disadvantage that the degree of washing of the product, i.e., the degree of depletion of the filterable constituents in the product, cannot be adjusted under the steady-state operating conditions that are essential for continuously operating multistage, large-scale plants, so that the quality and quantity of the concentrate and permeate streams that are produced can be controlled only to a limited extent.

### DESCRIPTION OF THE INVENTION

Therefore, the objective of the invention is to develop methods and devices that do not have the disadvantages of the prior art or at least partially avoid these disadvantages.

This objective is achieved by the method, the device, and the filtration plant in accordance with the independent claims. The first aspect of the invention concerns a method for the diafiltration of a product. In this method, a first fluid stream, which consists of a wash fluid that is external to the product, e.g., water, and a second fluid stream, which consists of a permeate that is derived from the product itself, e.g., permeate returned from the filtration means that are used or permeate produced by other filtration methods, are fed to a stream that consists of a product to be diafiltered, e.g., a stream of concentrated fruit juice, which is being fed to membrane filtration means to be filtered, in such a way that the product stream is diluted by the first and second fluid streams before it enters the membrane filtration means. In this connection, the quantitative ratio of the wash fluid supplied as the first fluid stream and the permeate supplied as the second fluid stream, which contains filterable constituents derived from the product itself, is adjusted or automatically controlled to a desired value. This provides the advantage that the degree of washing, which is maximal when exclusively wash fluid that is external to the product is supplied and minimal when exclusively permeate that is derived from the product is supplied, can be adjusted or automatically controlled, and the quality and quantity of the concentrate and permeate streams that are produced can be adjusted or automatically controlled within broad limits even under the steady-state operating conditions that are necessary for continuously operating multistage, large-scale production plants. The degree of washing can be expressed, for example, as a percent, and in this case can be calculated as follows:
Degree of washing=(C₀−C_{df})/C₀×100%
where C₀ is the initial concentration of filterable substances in the product before the diafiltration, and C_{df} is the final concentration of filterable substances in the product after the diafiltration.

In addition, in a preferred embodiment of the method, the total fluid supply comprising the first and second fluid streams can be adjusted or automatically controlled, which makes it possible to adjust or automatically control the viscosity of the product stream leaving the membrane filtration means as retentate.

If the permeate flow of the membrane filtration means, i.e., the volume or mass flow of the permeate produced with the membrane filtration means, is measured, and the total amount of the fluid supply consisting of the sum of the volume or mass flows of the first and second fluid feed streams is adjusted as a function of the permeate flow, a specific degree of concentration or dilution of the product leaving the membrane filtration means can be systematically adjusted or automatically controlled. Concentration or dilution of this product stream can also be systematically avoided by feeding exactly the same total amount of fluid as is removed as permeate by the membrane filtration module.

In another preferred embodiment, the first and second fluid streams are supplied as fluid streams that can be adjusted independently of each other. This makes it possible to adjust or automatically control both the ratio of the fluid streams to each other and the total fluid supply in a simple way.

In yet another preferred embodiment of the invention, the circulated product stream to be diafiltered is circulated through the membrane filtration means, so that, if desired, the filterable constituents can be practically completely washed out, i.e., a degree of washing of almost 100% can be realized.

If a permeate produced by the membrane filtration means of this diafiltration method is used as the second fluid stream, then, if desired, washing out of the filterable constituents can be completely prevented (corresponding to a degree of washing of 0%) by returning the total amount of permeate that is produced to the product stream to be filtered. In this regard, if, as explained above, the product stream to be filtered is circulated through the membrane filtration means, the degree of washing can be adjusted to any desired value between 0% and 100%.

In yet another preferred embodiment of the method, it is ensured that the pressure on the permeate side of the membrane filtration means is essentially constant and is decoupled from the total amount of permeate and wash fluid supplied and from the ratio of these fluid streams. This makes it possible to prevent the occurrence of negative transmembrane pressures, which can lead to destruction of the membranes, especially in the case of membrane filtration means with laminated membranes. The permeate side of the membrane filtration means is preferably maintained at atmospheric pressure, since this can be accomplished in a simple and reliable way by ventilation.

In yet another preferred embodiment of the method, the product that is being supplied as the product stream has been previously washed in one or more upstream diafiltration processes. Accordingly, a multistage diafiltration is carried out, in which the diafiltration method explained above is preceded by other diafiltration processes, so that a product stream from which filterable constituents have already been removed is supplied to the process explained above. High washing efficiency at a high product throughput can be realized in this way even in continuous filtration processes.

In this regard, it is preferred if exclusively permeate derived from the product is used as the wash fluid in the upstream diafiltration processes. This permeate is preferably produced in the given diafiltration process and/or in a diafiltration process directly following it. In this way, one uses as wash fluid only permeate which contains the same amount of filterable constituents as or a smaller amount of filterable constituents than the permeate produced in the given process, so that it is possible to dispense with the use of wash fluid external to the product, and, all together, a maximal washing efficiency at a maximal concentration of the filterable constituents in the permeate can be realized with a minimal amount of wash fluids that are external to the product over the successive diafiltration processes.

In multistage diafiltration processes of this type, the amounts of permeate produced by the membrane filtration means in the individual upstream diafiltration processes are preferably individually measured, and the amounts of permeate supplied as wash fluid to the individual diafiltration processes are adjusted or automatically controlled in each case as a function of these measured amounts of permeate. In this way, stable operating conditions can be ensured even in the case of varying product grades, which is extremely important for continuously operating multistage, large-scale plants to guarantee economical and reliable operation. In this regard, it is preferred if the permeate supplied as wash fluid in a given diafiltration process corresponds to 10% to 100%, and preferably 80% to 100%, of the amount of permeate produced in the given process, with the product stream becoming concentrated when the value is less than 100%.

In multistage diafiltration processes of this type, it is also preferred if the permeate sides of the membrane filtration means of at least the upstream diafiltration processes or of all of the diafiltration processes are maintained at a uniform, constant pressure. This makes it possible to keep the process management and the plant-engineering expense low. In this regard, it is preferred that the permeate sides be maintained at essentially atmospheric pressure, because this can be accomplished in an especially simple and reliable way.

If the permeate sides of the membrane filtration means of the upstream diafiltration processes or of all of the diafiltration processes are connected with one another by a connecting line, one obtains a design of the filtration plant that is especially reliable and easily surveyed.

In other preferred embodiments of the method, additional membrane filtration processes, preferably nanofiltration, ultrafiltration, and/or microfiltration processes, are carried out upstream of the diafiltration process or processes. A method of this type constitutes a production method with which a crude product can be separated into filterable and nonfilterable constituents economically and, if desired, practically completely.

A fruit juice, preferably a drupe juice, berry juice, citrus juice, pineapple juice, grape juice, apple juice, or pear juice, is preferably used as the product in the method in accordance with the first aspect of the invention. The advantages of the method of the invention become especially apparent with products of this type.

A second aspect of the invention concerns a device for carrying out the method in accordance with the first aspect of the invention. The device has membrane filtration means, e.g., a system of several parallel-connected and/or series-connected membrane filtration modules that have a product inlet, a product outlet, and a permeate outlet. The device also has a product supply line for feeding a product stream to the product inlet, a wash fluid supply line for feeding a wash fluid stream to the product stream, a permeate supply line for feeding a permeate stream derived from the product itself to the product stream, and adjusting means for adjusting or automatically controlling the ratio of the wash fluid stream and permeate stream fed to the product supply line and preferably also for adjusting or automatically controlling the total amount of fluid supplied with the first and second fluid streams. This device makes it possible to carry out diafiltration in accordance with the first aspect of the invention and to adjust or automatically control the quality and quantity of the concentrate and permeate streams that are produced within wide limits.

In a preferred embodiment, the wash fluid and permeate streams that are fed or can be fed to the product stream can be adjusted independently of each other, so that both the ratio of these streams to each other and the total amount of these streams fed to the product stream can be adjusted or automatically controlled by this independent adjustment or automatic control.

Furthermore, in another preferred embodiment of the device, the device includes an automatic control system associated with the adjusting means. This automatic control system allows automatic adjustment or control, in a closed-loop control system, of the total amount of fluid, comprising the amount of wash fluid that is supplied and the amount of permeate that is supplied, and/or of the ratio of the amount of wash fluid that is supplied to the amount of permeate that is supplied, preferably as a function of process parameters measured continuously or at intervals, for example, the viscosity of the product, the amount of permeate produced by the membrane filtration means, or the pressure at the product inlet. In this way, a certain constant degree of washing and possibly a certain constant viscosity of the product stream discharged from the membrane filtration means can be automatically ensured even in the case of varying product grades.

The permeate supply line is preferably designed as a permeate return line for returning permeate from the permeate outlet of the membrane filtration means to the product stream. This makes it possible to eliminate externally supplied permeate and to use not only the wash fluid but also permeate produced by the membrane filtration means of the device for diluting the product before the filtration is carried out.

In another preferred embodiment of the device, the product inlet and product outlet of the membrane filtration means are connected with each other by a circulation pump to form a product circulation. This makes it possible first to dilute at least a portion of the product repeatedly with wash fluid and permeate and then to filter it and thus increase the degree of washing of the device compared to a simple continuous-flow filtration.

In this regard, it is preferred if a product feed line for feeding a product stream to the product circulation and a product discharge line for discharging a product stream from the product circulation are provided to allow continuous operation of the device.

In devices of this type, the product feed line preferably opens into the product circulation upstream of the product discharge line, so that product freshly fed into the product circulation is reliably prevented from flowing off into the product discharge line, and the product is fed to the membrane filtration means by the flow.

It is also preferred for the product feed line and the product discharge line to be arranged in the product circulation in the region between the product outlet of the membrane filtration means and the circulation pump, so that the available pumping capacity is fully available for supplying the membrane filtration means.

It is also advantageous if the wash fluid feed line opens into the product circulation in the region between the product outlet of the membrane filtration means and the circulation pump, preferably in the region between the product discharge line and the circulation pump, since this reliably prevents wash fluid feed from flowing off into the product discharge line. The same applies analogously to the arrangement of the permeate supply line.

In another preferred embodiment of the device, the wash fluid supply line and the permeate supply line open into the product stream by two separate openings or by a common opening; the latter case provides the advantage that the wash fluid and the permeate can already mix before they enter the product stream.

In yet another preferred embodiment, the device is designed in such a way that the pressure at the permeate outlet of the filtration means is independent of the amounts of wash fluid and permeate that are supplied, so that a change in these amounts does not cause a change in the pressure at the permeate outlet. In this regard, it is advantageous if the device is designed in such a way that the pressure at the permeate outlet is essentially constant at atmospheric pressure, which can be accomplished, for example, by using a ventilated permeate discharge line. A buildup of pressure on the permeate side of the membrane filtration means, which can lead to destruction of the membrane in the case of laminated membranes, can be reliably prevented in this way.

If a preferably automatically controlled permeate pump and/or wash fluid pump is installed in the permeate supply line and/or in the wash fluid supply line, the permeate and/or the wash fluid can also be supplied at low pressures, e.g., from a tank under atmospheric pressure. Moreover, in the case of automatically controlled and preferably volumetric pumps, the amounts of permeate and/or wash fluid that are supplied can be adjusted or automatically controlled in a simple way.

A third aspect of the invention concerns a filtration plant with a device in accordance with the second aspect of the invention. The filtration plant is preferably a continuously operating membrane filtration plant. The invention can be used especially productively with filtration plants of this type.

In a preferred embodiment, the filtration plant has one or more additional diafiltration stages upstream of its device in accordance with the second aspect of the invention. In addition, the filtration plant is designed in such a way that the additional diafiltration stages can be supplied exclusively with their own permeate and/or permeate from the other diafiltration stages as the wash fluid, and it is preferred if each additional diafiltration stage can be supplied with permeate from the next downstream diafiltration stage. In this way, a maximal degree of washing can be realized with a minimal amount of external wash fluid, and a minimal total amount of permeate with a maximal concentration of filterable substances in the permeate is produced.

In another preferred embodiment of the filtration plant, the additional diafiltration stages have adjusting means, by which the amounts of permeate fed to the individual stages by the permeate supply lines can be adjusted, preferably independently of one another and preferably in such a way that the given amount of permeate supplied in each case is equal to the permeate output of the given diafiltration stage. In this way, the viscosity of the product can be adjusted for each diafiltration stage, and reliable operation of the filtration plant can be ensured.

In this regard, it is preferred if the adjusting means include an automatic control system, with which the given amount of permeate supplied by the permeate supply line can be automatically adjusted, preferably to the amount of permeate of the given diafiltration stage, so that concentration of the product in the given diafiltration stage can be prevented.

The filtration plant is preferably designed in such a way that the pressures on the permeate sides of the filtration means of the additional diafiltration stages are independent of the amounts of permeate supplied by the permeate supply lines, so that a change in these amounts does not result in any significant change in the pressures on the permeate sides of the filtration means. This provides a simple means of maintaining the transmembrane pressures at a constant level.

It is also preferred if the permeate sides of the filtration means of the additional diafiltration stages or of all of the diafiltration stages of the filtration plant are connected with one another, so that essentially the same pressure exists on the permeate sides of the filtration means during the operation. This reduces the plant-engineering expense and makes process management easier. If the permeate sides can communicate with the environment, so that the pressure corresponds essentially to atmospheric pressure, then this can be accomplished in an especially simple way, and the occurrence of negative transmembrane pressures can be reliably prevented.

In this regard, if the permeate sides of the filtration means of the additional diafiltration stages are each connected with the permeate supply line of the upstream diafiltration stage by preferably automatically controlled permeate pumps, an optimum washing efficiency is realized.

In yet another preferred embodiment, the filtration plant has nanofiltration, ultrafiltration, and/or microfiltration stages upstream of the diafiltration stages. Filtration plants of this type make it possible to separate liquid starting products economically and, if desired, practically completely into filterable and nonfilterable substances.

A fourth aspect of the invention concerns the use of the device in accordance with the second aspect of the invention or the filtration plant in accordance with the third aspect of the invention for the filtration of fruit juice, especially a drupe juice, berry juice, citrus juice, pineapple juice, grape juice, apple juice, or pear juice. The advantages of the invention become apparent especially apparent in this application.

### BRIEF DESCRIPTION OF THE DRAWINGS

Further embodiments, advantages and applications of the invention are specified in the dependent claims and are described below with reference to the drawings.

FIG. 1 shows a schematic representation of a device of the invention in the form of a single diafiltration stage.

FIG. 2 shows a schematic representation of a filtration plant of the invention with single-stage diafiltration and multistage ultrafiltration upstream of the diafiltration.

FIG. 3 shows a schematic representation of another filtration plant of the invention with multistage countercurrent diafiltration and multistage ultrafiltration upstream of the diafiltration.

### METHODS FOR CARRYING OUT THE INVENTION

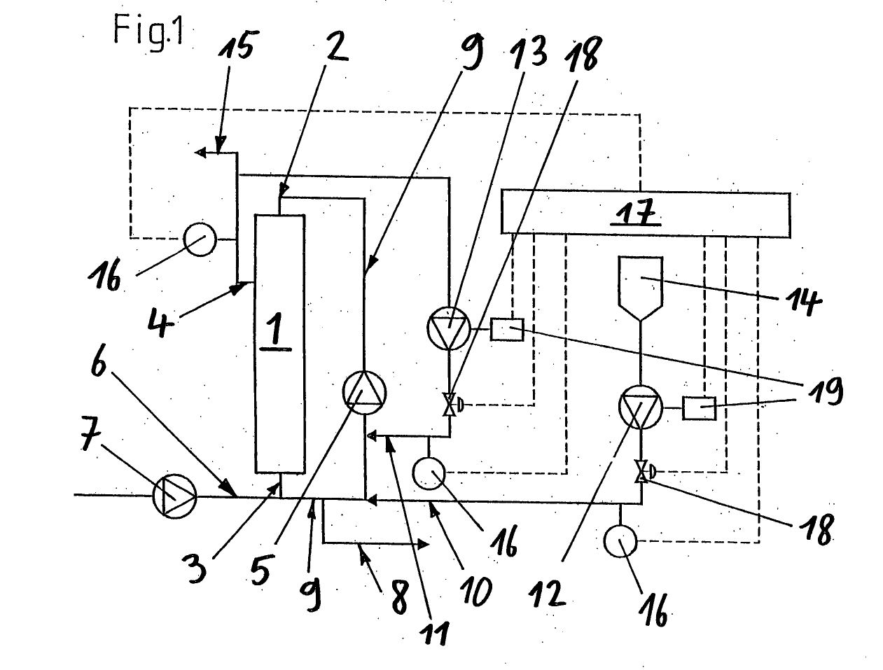

The basic principle of the invention is illustrated in FIG. 1, which shows the system diagram of a device of the invention in the form of a single diafiltration stage. As the diagram shows, the diafiltration stage has a cross-flow filtration element 1 as the membrane filtration means with a product inlet 2, a product outlet 3, and a permeate outlet 4. The product inlet 2 and the product outlet 3 are connected by a circulation line 9 with a circulation pump 5 to form a product circulation, wherein the circulation line 9 constitutes a product supply line as specified in the claims. Product with filterable constituents can be continuously fed to the product circulation through a product feed line 6 by a feed pump 7, and product with a reduced concentration of filterable constituents compared to the supplied product can be removed through a product discharge line 8. Accordingly, this is an open product circulation that allows continuous operation of the diafiltration stage. Between the product discharge line 8 and the intake side of the circulation pump 5, a wash fluid supply line 10 and a permeate supply line 11 open into the product supply line 9 and thus into the product circulation. Specific amounts of wash fluid (water in this case) and permeate can be fed through the wash fluid supply line 10 and the permeate supply line 11 by means of a wash fluid pump 12 and a permeate pump 13, respectively, into the product stream flowing in the product supply line 9 in order to dilute it. While the wash fluid pump 12 draws its wash fluid from a wash fluid tank 14, the permeate supply line 11 is designed as a permeate return line 11 by connecting the intake side of the permeate pump 13 with the permeate outlet 4 of the cross-flow filtration element 1 and thus with the permeate side of its filter membranes. A permeate discharge line 15 is also connected with the permeate outlet 4 to allow excess permeate to be removed and fed to a permeate collecting tank (not shown). Flowmeters 16, with which the permeate flow produced by the filtration element 1 and the amounts of permeate and wash fluid supplied to the product stream can be separately measured, are installed in the permeate outlet 4 of the cross-flow filtration element 1, in the permeate supply line 11, and in the wash fluid supply line 10. The flowmeters 16 are functionally connected with an automatic control system 17, which, if necessary, can carry out a control action as a function of the measured flow amounts according to specific predetermined criteria for the purpose of adjusting a specific quantitative ratio between the amount of permeate supplied and the amount of wash fluid supplied and/or adjusting a specific quantitative ratio between the amount of permeate produced by the filtration element 1 and the total amount of wash fluid and permeate supplied to the product stream. If a control action is necessary, it is carried out by activating throttle valves 18 in the permeate supply line 11 and the wash fluid supply line 12 or by automatically controlling the speeds of the permeate pump 13 and wash fluid pump 12 by means of frequency converters 19. Both possibilities are shown schematically in FIG. 1.

If, for example, a maximum degree of concentration of the product emerging from the filtration element 1 is not to be exceeded, the automatic control system 17 determines, by means of the flowmeters 16, the permeate flow produced by the filtration element 1 and the amounts of permeate and wash fluid supplied through the permeate supply line 11 and the wash fluid supply line 10 and automatically controls the latter amounts in such a way that a desired ratio is obtained between the permeate flow that is produced and the amount of fluid that is supplied as permeate and wash fluid. If, in addition, a specific degree of washing is to be realized, the ratio between the amount of permeate that is supplied and the amount of wash fluid that is supplied is adjusted to a specific value, with the degree of washing increasing with increasing amount of wash fluid and decreasing amount of permeate.

If it is desired that the product emerging from the filtration element 1 should neither be concentrated nor diluted, then the total amount of permeate and wash fluid that is supplied is adjusted or automatically controlled to a value that is equal to the permeate flow produced by the filtration element.

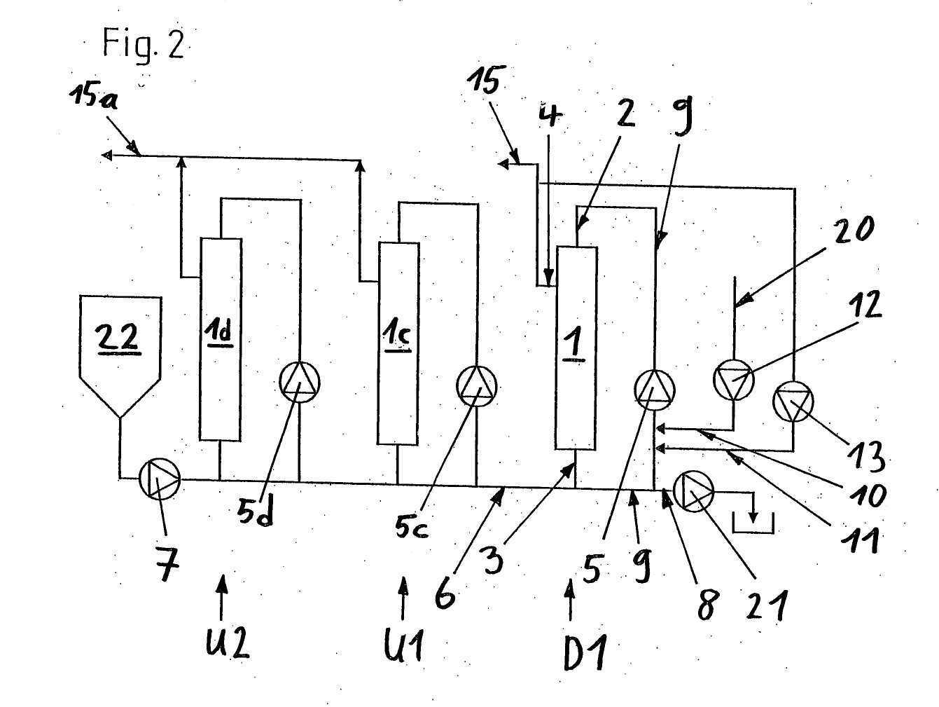

FIG. 2 shows a schematic representation of a multistage filtration plant of the invention for fruit juices. The filtration plant has two series-connected ultrafiltration stages U2, U1 and a downstream diafiltration stage D1 of the type illustrated in FIG. 1, except that in this case the wash fluid is supplied from a water main 20, and a retentate pump 21, which pumps the product volumetrically and is operated as a throttle pump, is installed in the product discharge line 8. In the present case, the product to be filtered consists of undiluted raw fruit juice and is supplied to the plant from a feed tank 22 by a feed pump 7. The diafiltration stage D1 of the filtration plant shown here also has an automatic control system, which, for the sake of simplicity, is not shown here.

The two ultrafiltration stages U1, U2 are constructed in a well-known way as open retentate circulation systems with cross-flow filtration elements 1c, 1d and circulation pumps 5c, 5d and are installed in series in the product feed line 6 of the diafiltration stage D1 in such a way that a product that is already concentrated is supplied to the product circulation of the diafiltration stage D1. The permeate sides of the cross-flow filtration elements 1c, 1d of the two ultrafiltration stages U1, U2 are connected with a permeate collecting line 15a, through which the permeate produced in these stages U1, U2 is removed and conveyed to a permeate tank (not shown). The permeate produced by the diafiltration stage D1, which contains not only filterable constituents derived from the product itself but also wash fluid external to the product and, in the present case of fruit juice filtration, constitutes a product that is diluted relative to the permeate of the ultrafiltration stages U1, U2, is removed through the permeate discharge line 15 and conveyed to a separate permeate tank for diafiltered permeate or to a common permeate tank (not shown).

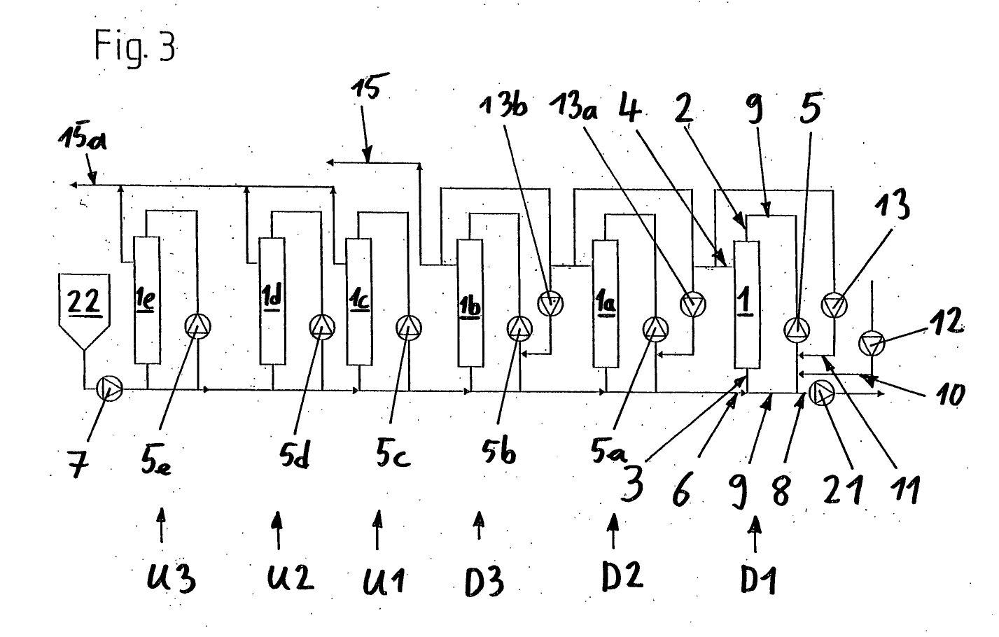

FIG. 3 shows a schematic representation of another filtration plant of the invention with multistage countercurrent diafiltration D1, D2, D3 and multistage ultrafiltration U1, U2, U3 upstream of the diafiltration. It differs from the filtration plant illustrated in FIG. 2 only in that there is a third ultrafiltration stage U3 with the same design as stages U1 and U2 and that two additional diafiltration stages D2, D3 are installed between the ultrafiltration stages U1, U2, U3 and the diafiltration stage D1. These additional diafiltration stages D2, D3 have practically the same design as diafiltration stage D1, except that they have no supply line for wash water. Instead of this, however, they are each connected on the intake side of their permeate pumps 13a, 13b not only with the permeate outlet of their own filtration elements 1a, 1b but also with the permeate outlet of the diafiltration stage D2, D1 immediately downstream, so that their product circulations can be supplied with their own permeate and/or permeate of the following diafiltration stage as wash fluid. In this way, the permeate outlets of the filtration elements 1, 1a, 1b of all of the diafiltration stages D1, D2, D3 are connected with one another and discharge excess diafiltered permeate into the diafiltered permeate discharge line 15, which serves as a collecting line and opens into a ventilated diafiltered permeate collecting tank or a permeate collecting tank (not shown). The collecting tank is maintained at atmospheric pressure by the ventilation. This is important in the present case, because the filtration elements 1, 1a, 1b are equipped with laminated membranes, which would be destroyed by a negative transmembrane pressure. The permeate outlets of the cross-flow filtration elements 1c, 1d, 1e of the ultrafiltration stages U1, U2, U3 are connected with a permeate collecting line 15a, through which the permeate produced in the stages U1, U2, U3 can be removed and conveyed to a permeate tank (also not shown), which is also ventilated.

While the present application describes preferred embodiments of the invention, it is to be clearly understood that the invention is not limited to these embodiments and can also be realized in other ways within the scope of the claims which follow. In particular, it should be noted that the invention is not limited to the illustrated continuous types of plants with an open product circulation, but rather other types of plants are also envisioned, for example, plants with a closed product circulation, in which the product is diafiltered in a batch operation until a certain degree of washing has been achieved, or plants with simple continuous-flow diafiltration without circulation of the product.

1-38. (canceled)

39. A method for the diafiltration of a product, which comprises the steps of:
(a) providing a product stream that consists of the product;
(b) providing a first fluid stream that consists of a wash fluid that is external to the product;
(c) providing a second fluid stream that comprises a permeate derived from the product itself;
(d) supplying the first and second fluid streams to the product stream in such a way that the product stream is diluted by the two fluid streams;
(e) feeding the product stream diluted with the first and second fluid streams to membrane filtration means; and
(f) adjusting the ratio of the two fluid streams to each other; wherein permeate from the membrane filtration means is supplied as the second fluid stream.

40. The method in accordance with claim 39, wherein the total amount of fluid supplied by the first and second fluid streams is adjusted.

41. The method in accordance with claim 39, wherein the ratio of the two fluid streams to each other is automatically adjusted in a closed-loop control system as a function of process parameters measured continuously or at intervals.

42. The method in accordance with claim 40, wherein the permeate flow of the membrane filtration means is measured, and the total amount of fluid supplied by the first and second fluid streams is adjusted as a function of the measured permeate flow.

43. The method in accordance with claim 39, wherein first and second fluid streams are adjusted independently of each other.

44. The method in accordance with claim 39, wherein the product stream is circulated through the membrane filtration means.

45. The method in accordance with claim 39, wherein the pressure on the permeate side of the membrane filtration means is maintained at an essentially constant level, independently of the total amount of fluid or independently of the ratio of the two fluid streams to each other.

46. The method in accordance with claim 39, wherein the product that is being supplied as the product stream has been previously washed in at least one upstream diafiltration process.

47. The method in accordance with claim 46, wherein the permeate is used as the wash fluid in the at least one upstream diafiltration process.

48. The method in accordance with claim 47, wherein, in the upstream diafiltration processes, the amounts of permeate supplied as wash fluid are adjusted, as a function of the amount of permeate produced by the membrane filtration means.

49. The method in accordance with claim 48, wherein the pressure on the permeate side of the membrane filtration means is maintained at a uniform, essentially constant level.

50. The method in accordance with claim 49, wherein the permeate sides of the membrane filtration means used in the upstream diafiltration processes or in all of the diafiltration processes are connected with one another by connecting lines.

51. The method in accordance with claim 46, wherein at least one additional membrane filtration process, is carried out upstream of the diafiltration process.

52. The method in accordance with claim 39, wherein the product is a fruit juice.

53. The method in accordance with claim 52 wherein the fruit juice is drupe juice, berry juice, citrus juice, pineapple juice, grape juice, apple juice, or pear juice.

54. A device for carrying out the diafiltration of a product, which comprises:
(a) membrane filtration means with a product inlet, a product outlet, and a permeate outlet;
(b) a product supply line for feeding a product stream to the product inlet of the membrane filtration means;
(c) a wash fluid supply line for feeding a wash fluid stream to the product stream;
(d) a permeate supply line for feeding a permeate stream derived from the product itself to the product stream; and
(e) adjusting means for adjusting the ratio of the wash fluid stream and the permeate stream that are fed to the product stream;
wherein the permeate supply line is designed as a permeate return line for returning permeate from the permeate outlet of the membrane filtration means to the product stream.

55. The device in accordance with claim 54, wherein the adjusting means are designed so that the wash fluid and permeate streams that are supplied can be adjusted independently of each other.

56. The device in accordance with claim 55, wherein the adjusting means comprise an automatic control system, with which the total amount of fluid, comprising the amount of wash fluid supplied and the amount of permeate supplied, and/or the ratio of the amount of wash fluid supplied to the amount of permeate supplied can be automatically adjusted or controlled in a closed-loop control system.

57. The device in accordance with claim 54, wherein the product inlet and product outlet of the membrane filtration means are connected by a circulation pump to form a product circulation.

58. The device in accordance with claim 57, which additionally comprises a product feed line for feeding a product stream to the product circulation and a product discharge line for discharging a product stream from the product circulation.

59. The device in accordance with claim 58 wherein the product feed line opens into the product circulation upstream of the product discharge line.

60. The device in accordance with claim 59, wherein the product feed line and the product discharge line are arranged in the product circulation in the region between the product outlet of the membrane filtration means and the circulation pump.

61. The device in accordance with claim 60, wherein the wash fluid feed line opens into the product circulation in the region between the product outlet of the membrane filtration means and the circulation pump.

62. The device in accordance with claim 61, wherein the permeate supply line opens into the product circulation in the region between the product outlet of the filtration means and the circulation pump.

63. The device in accordance with claim 62, wherein the wash fluid supply line and the permeate supply line open into the product stream by two separate openings or by a common opening.

64. The device in accordance with claim 62, wherein the device is designed in such a way that the pressure at the permeate outlet of the filtration means is independent of the amounts of wash fluid and permeate that are supplied, so that a change in these amounts does not cause a change in the pressure at the permeate outlet.

65. The device in accordance with claim 64, wherein a permeate pump is installed in the permeate supply line.

66. The device in accordance with claim 64, wherein a wash fluid pump is installed in the wash fluid supply line.

67. A filtration plant comprising a device in accordance with claim 54.

68. The filtration plant wherein one or more additional diafiltration stages are installed upstream of the device in accordance with claim 54, and wherein the filtration plant is designed in such a way that the additional diafiltration stages can be supplied exclusively with their own permeate and/or permeate of the next downstream diafiltration stage.

69. The filtration plant in accordance with claim 68, wherein the additional diafiltration stages have adjusting means, by which the amounts of permeate fed to the individual stages can be adjusted.

70. The filtration plant in accordance with claim 69, wherein the adjusting means include an automatic control system, with which the given amount of permeate that is supplied can be automatically adjusted.

71. The filtration plant in accordance with claim 68, wherein the pressures on the permeate sides of the membrane filtration means of the additional diafiltration stages are independent of the given amounts of permeate that are supplied, so that a change in these amounts does not result in any significant change in the pressures on the permeate sides of the filtration means.

72. The filtration plant in accordance with claim 68, wherein the permeate sides of the filtration means of the additional diafiltration stages or of all of the diafiltration stages of the filtration plant are connected with one another in such a way that essentially the same pressure exists on the permeate sides of the filtration means during the operation.

73. The filtration plant in accordance with claim 72, wherein the permeate sides of the filtration means of the additional diafiltration stages are each connected with the permeate outlets of the filtration means of the upstream diafiltration stage by permeate pumps.

74. The filtration plant in accordance with claim 68, wherein the plant has nanofiltration, ultrafiltration, and/or microfiltration stages upstream of the diafiltration stages.
